(19) United States
(12) Patent Application Publication
(10) Pub. No.: US 2026/0094272 A1
(43) Pub. Date: Apr. 2, 2026

(54) MEDICAL IMAGE PROCESSING SYSTEM, MEDICAL IMAGE PROCESSING APPARATUS, AND MEDICAL IMAGING APPARATUS

(71) Applicant: Canon Medical Systems Corporation, Otawara-shi (JP)

(72) Inventors: Shuhei BANNAE, Utsunomiya (JP); Yusuke IMASUGI, Tokyo (JP); Kyohei YAMAMORI, Kawasaki (JP); Kyoko WATANABE, Nasushiobara (JP); Takahiko NISHIOKA, Otawara (JP)

(73) Assignee: Canon Medical Systems Corporation, Otawara-shi (JP)

(21) Appl. No.: 19/343,436

(22) Filed: Sep. 29, 2025

(30) Foreign Application Priority Data
Sep. 30, 2024 (JP) 2024-170605

(51) Int. Cl. G06T 7/00

(52) U.S. Cl. CPC G06T 7/0014; G06T 2200/24; G06T 2207/30016; G06T 2207/30096; G06T 2207/30104

(57) ABSTRACT

A medical image processing apparatus receives a first medical image related to a subject from a medical imaging apparatus. The medical image processing apparatus executes a first analysis process for the first medical image to output a first analysis result. The medical image processing apparatus determines, based on the first analysis result, whether or not a second analysis process is required as an additional analysis process. The medical image processing apparatus establishes, if it has been determined that the second analysis process is required, an image characteristic recommended to be equipped in a second medical image used in the second analysis process in accordance with a processing content of the second analysis process.

### CROSS-REFERENCE TO RELATED APPLICATIONS

This application is based upon and claims the benefit of priority from Japanese Patent Application No. 2024-170605, filed Sep. 30, 2024, the entire contents of which are incorporated herein by reference.

### FIELD

Embodiments described herein relate generally to a medical image processing system, a medical image processing apparatus, and a medical imaging apparatus.

### BACKGROUND

A medical image processing apparatus for automatic analysis communicably connected to a medical imaging apparatus is known. The medical image processing apparatus receives a medical image generated by the medical imaging apparatus, executes an analysis process for the received medical image, and transmits a result of the analysis to a picture archiving and communication system (PACS), etc. There is a case where, depending on the result of the analysis, a healthcare professional such as a radiographer or a doctor determines that an additional analysis process should be executed. However, it is not easy to specify a medical image suitable for the additional analysis process, and even if a medical image is specified, additional imaging for the medical image places a burden on the healthcare professional and the patient.

### BRIEF DESCRIPTION OF THE DRAWINGS

FIG. 1 is a diagram showing a configuration example of a medical image processing system.

FIG. 2 is a diagram showing a configuration example of a medical imaging apparatus.

FIG. 3 is a diagram showing a configuration example of a medical image processing apparatus.

FIG. 4 is a diagram showing a flow of an automatic analysis process by the medical image processing system.

FIG. 5 is a diagram schematically representing a first analysis result.

FIG. 6 is a diagram showing an example of head MR images.

FIG. 7 is a diagram showing an example of a display screen of a first analysis result and a second analysis result.

FIG. 8 is a diagram showing a display example of a confirmation window.

FIG. 9 is a diagram showing a flow of an automatic analysis process by the medical image processing system according to Modification 2.

FIG. 10 is a diagram showing a configuration example of the medical image processing apparatus according to Modification 7.

FIG. 11 is a diagram showing a flow of an automatic analysis process by the medical image processing system according to Modification 7.

### DETAILED DESCRIPTION

A medical image processing system according to an embodiment includes a medical image processing apparatus and a medical imaging apparatus, which are communicably connected to each other. The medical image processing apparatus includes a receiving unit, an analyzing unit, a determining unit, and an establishing unit. The receiving unit receives a first medical image related to a subject from the medical imaging apparatus. The analyzing unit executes a first analysis process for the first medical image to output a first analysis result. The determining unit determines, based on the first analysis result, whether or not a second analysis process is required as an additional analysis process. The establishing unit establishes, if it has been determined that the second analysis process is required, an image characteristic recommended to be equipped in a second medical image used in the second analysis process in accordance with a processing content of the second analysis process.

Hereinafter, a medical image processing system, a medical image processing apparatus, and a medical imaging apparatus according to the present embodiment will be described in detail with reference to the accompanying drawings.

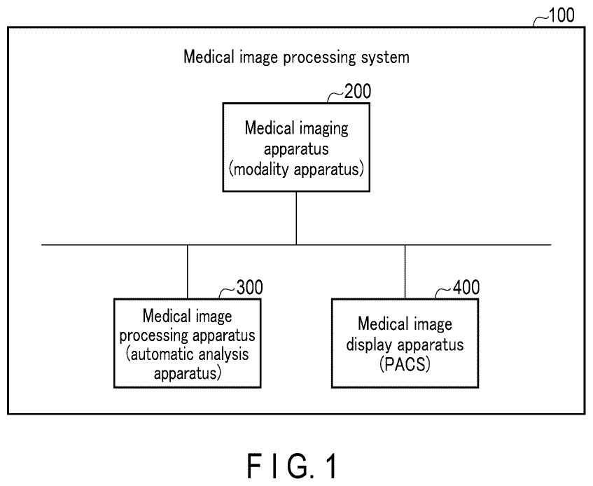

FIG. 1 is a diagram showing a configuration example of a medical image processing system 100. The medical image processing system 100 is a computer network system configured to image medical images, perform an automatic analysis of the medical images, and provide a result of the analysis. As shown in FIG. 1, the medical image processing system 100 includes a medical imaging apparatus 200, a medical image processing apparatus 300, and a medical image display apparatus 400. The medical imaging apparatus 200, the medical image processing apparatus 300, and the medical image display apparatus 400 are connected to a given network to enable mutual communications therebetween. A “network” indicates a general information communication network that employs electric communication technology. The network may be, as well as a wireless/wired local area network (LAN) such as a hospital backbone LAN and an Internet network, a telephone communication network, an optical fiber communication network, a cable communication network, a satellite communication network, etc.

The medical imaging apparatus 200 is configured to execute a medical imaging for subject and to acquire a medical image related to the subject. The medical imaging apparatus 200 is also referred to as a “modality apparatus”. A medical image is transmitted to the medical image processing apparatus 300. The medical image processing apparatus 300 is a computer configured to perform an analysis process on the medical image. An analysis result of the analysis process is transmitted to the medical image display apparatus 400. The medical image display apparatus 400 is a computer configured to display the analysis result. As an example, the medical image display apparatus 400 is realized by a computer included in a PACS, which is a medical image storage system.

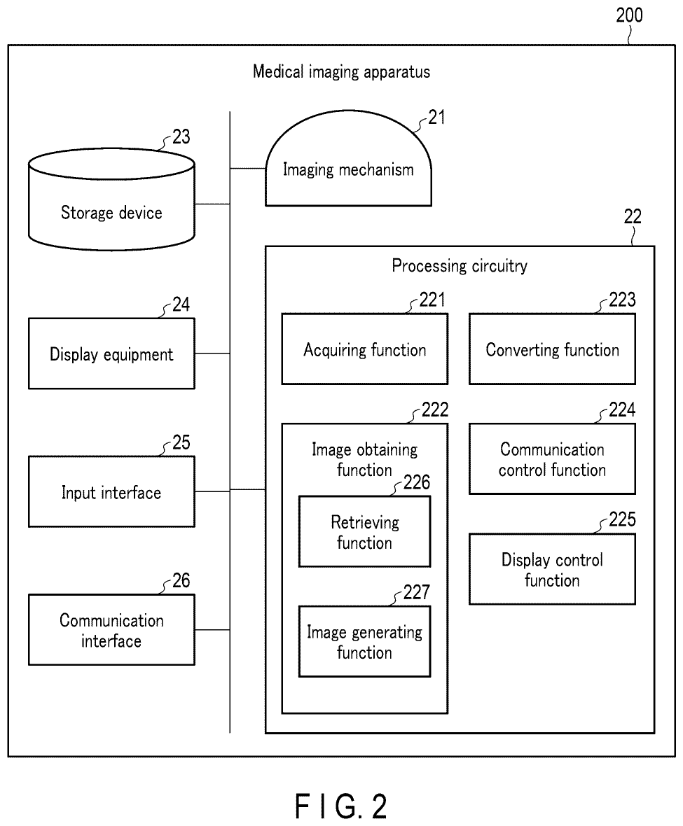

FIG. 2 is a diagram showing a configuration example of the medical imaging apparatus 200. As shown in FIG. 2, the medical imaging apparatus 200 includes an imaging mechanism 21, processing circuitry 22, a storage device 23, display equipment 24, an input interface 25, and a communication interface 26. The imaging mechanism 21, the processing circuitry 22, the storage device 23, the display equipment 24, the input interface 25, and the communication interface 26 are communicably connected to each other via a bus.

The imaging mechanism 21 is a mechanical device configured to carry out medical imaging on a subject. By carrying out the medical imaging, the imaging mechanism 21 acquires raw data on the subject via a detector of various types. Specifically, the imaging mechanism 21 may be a single-modality apparatus such as a magnetic resonance imaging (MRI) apparatus, an X-ray computed tomography (CT) apparatus, an X-ray diagnosis apparatus, an ultrasound diagnosis apparatus, a positron emission tomography (PET) apparatus, or a single photon-emission computed tomography (SPECT) apparatus, or a multi-modality apparatus such as a PET/CT apparatus, a SPECT/CT apparatus, a PET/MRI apparatus, or a SPECT/MRI apparatus.

In the case where, as an example, the imaging mechanism 21 is an MRI apparatus, the imaging mechanism 21 repeatedly performs application of a gradient field via a gradient field coil and application of an RF pulse via a transmit coil under an application of a static magnetic field via a static field magnet. As a result of the application of the RF pulse, an MR signal is emitted from the subject. The emitted MR signal is received via a receive coil. The received MR signal undergoes signal processing such as A/D conversion by reception circuitry. The MR signal after the A/D conversion is referred to as “k-space data”. The k-space data is an example of raw data.

The processing circuitry 22 includes a processor such as a central processing unit (CPU). The processor is configured to activate various programs installed on the storage device 23, etc., thereby realizing an acquiring function 221, an image obtaining function 222, a converting function 223, a communication control function 224, and a display control function 225. The configuration is not limited to the case where the functions 221 to 225 are realized by a single processing circuit. The functions 221 to 225 may be realized by allowing a plurality of independent processors, which in combination configure processing circuitry, to execute the corresponding programs.

The acquiring function 221 is configured to acquire raw data on the subject by controlling the imaging mechanism 21 to carry out medical imaging on the subject. If, for example, the imaging mechanism 21 is an MRI apparatus, k-space data is acquired as the raw data. The acquiring function 221 is an example of an acquiring unit.

The image obtaining function 222 is configured to obtain a medical image related to the subject. A “medical image” refers to digital data of a two-dimensional or three-dimensional array of pixel values. The image obtaining function 222 is performed at a first medical image generating stage (medical imaging stage) and a second medical image obtaining stage (second analysis processing stage). A first medical image is a medical image after a first analysis process. The “first analysis process” refers to an initially set analysis process. A second medical image is a medical image after an analysis process (a second analysis process) determined to be necessary in accordance with an analysis result (a first analysis result) of the first analysis process on the first medical image. The second medical image has an image characteristic recommended to be equipped in accordance with a processing content of the second analysis process. The “second medical image obtaining stage” refers to a stage at which the second medical image is obtained. At the second analysis processing stage, the image obtaining function 222 obtains a second medical image equipped with the image characteristic, without performing additional medical imaging. The image obtaining function 222 is an example of an image obtaining unit.

Specifically, as shown in FIG. 2, the image obtaining function 222 includes a retrieving function 226 and an image generating function 227. The retrieving function 226 may be used at the second medical image obtaining stage. If a second medical image is stored in the storage device 23, the second medical image is retrieved and read from the storage device 23. Through the retrieving process, the second medical image is obtained. The retrieving function 226 is an example of a retrieving unit.

The image generating function 227 may be used at the first medical image generating stage and the second medical image obtaining stage. At the first medical image generating stage, the image generating function 227 generates a first medical image related to the subject from the raw data acquired by the acquiring function 221. At the second medical image obtaining stage, the image generating function 227 reads raw data necessary for reconstruction of the second medical image from the storage device 23, and generates the second medical image related to the subject from the read raw data based on an image generation condition corresponding to the image characteristic of the second medical image. Alternatively, at the second medical image obtaining stage, the image generating function 227 reads an original image of the second medical image from the storage device 23, and generates the second medical image from the read raw image based on an image generation condition corresponding to the image characteristic of the second medical image. The image generating function 227 is an example of an image generation unit.

The converting function 223 is configured to convert the image characteristic of the second medical image into the image generation condition for generating the second medical image defined by a specification adopted by the medical imaging apparatus 200. The image generation condition is used for, for example, generation of the second medical image by the image obtaining function 222. In the case where the image generation condition is established by the medical image processing apparatus 300, etc., the converting function 223 may not be provided. The converting function 223 is an example of a converting unit.

The communication control function 224 is configured to transmit and receive a variety of data via the communication interface 26 to and from the medical image processing apparatus 300 and the medical image display apparatus 400. As an example, the communication control function 224 receives, from the medical image processing apparatus 300, an obtaining request for the second medical image and an image characteristic recommended to be equipped in the second medical image. As another example, the communication control function 224 transmits the generated second medical image to the medical image processing apparatus 300. The communication control function 224 is an example of a transmission unit and a reception unit.

The display control function 225 is configured to display a variety of data on the display equipment 24. As an example, the display control function 225 displays, on the display equipment 24, a window for allowing a user to confirm whether or not to accept provision of the second medical image.

The storage device 23 is a storage device configured to store various types of data, such as a read-only memory (ROM), a random-access memory (RAM), a hard disk drive (HDD), a solid-state drive (SSD), an integrated-circuit storage device, etc. Other than such storage devices, the storage device 23 may be a portable storage medium such as a compact disc (CD), a digital versatile disc (DVD), or a flash memory, or a driver configured to read and write various types of information to and from a semiconductor memory device. The storage device 23 may be located within another computer connected via a network to the medical imaging apparatus 200.

The display equipment 24 is configured to display a variety of data. The display equipment 24 may be a liquid crystal display (LCD), a cathode-ray tube (CRT) display, an organic electroluminescence display (OELD), a plasma display, or any other display available. The display equipment 24 may also be a projector.

The input interface 25 is configured to receive various input operations from a user, convert the received input operations into electrical signals, and output them to the processing circuitry 22. Specifically, the input interface 25 is connected to input equipment such as a mouse, a keyboard, a track ball, switches, buttons, a joystick, a touch pad, and/or a touch panel display. The input interface 25 is configured to, in response to an input operation to the input equipment, output an electric signal to the processing circuitry 22. Note that the input equipment connected to the input interface 25 may be provided on another computer connected via a network, etc. The input interface 25 may be a speech recognition device configured to convert an audio signal acquired by a microphone into an instruction signal.

The communication interface 26 includes a network interface card (NIC) for performing communication connection with an external device such as the medical image processing apparatus 300 and the medical image display apparatus 400.

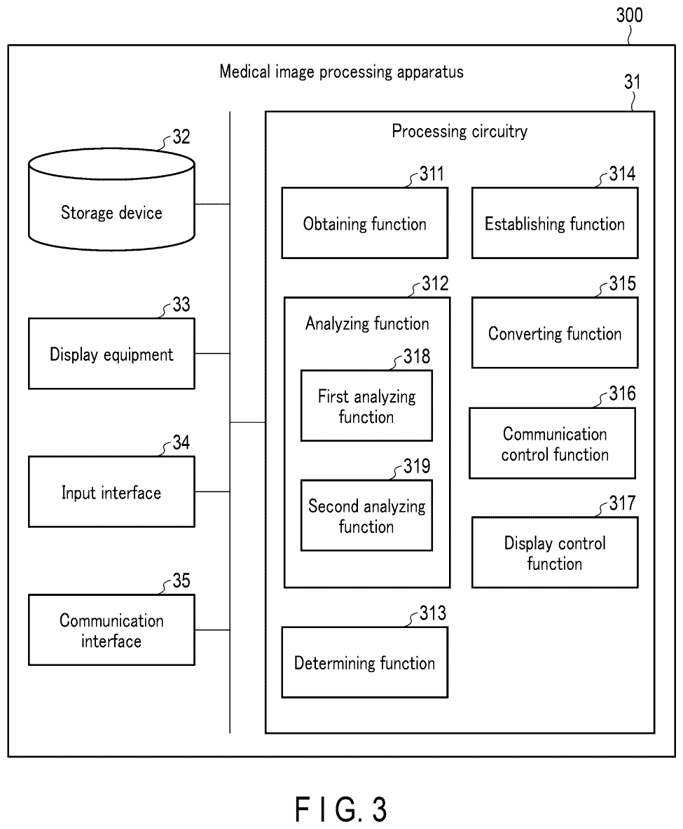

FIG. 3 is a diagram showing a configuration example of the medical image processing apparatus 300. As shown in FIG. 3, the medical image processing apparatus 300 includes processing circuitry 31, a storage device 32, display equipment 33, an input interface 34, and a communication interface 35. The processing circuitry 31, the storage device 32, the display equipment 33, the input interface 34, and the communication interface 35 are communicably connected to each other via a bus.

The processing circuitry 31 includes a processor such as a central processing unit (CPU). The processor is configured to activate various programs installed on the storage device 32, etc., thereby realizing an obtaining function 311, an analyzing function 312, a determining function 313, an establishing function 314, a converting function 315, a communication control function 316, a display control function 317, etc. The configuration is not limited to the case where the functions 311 to 317 are realized by a single processing circuit. The functions 311 to 317 may be realized by allowing a plurality of independent processors, which in combination configure processing circuitry, to perform the corresponding programs.

The obtaining function 311 is configured to obtain the first medical image related to the subject, acquired by the medical imaging apparatus 200. Specifically, the obtaining function 311 obtains the first medical image received from the medical imaging apparatus 200 via the communication interface 35. The processing circuitry 31 may be configured to obtain data of various other types. The obtaining function 311 is an example of an obtaining unit.

The analyzing function 312 is configured to executes an analysis process for a medical image to output an analysis result. The analysis process according to the present embodiment is realized by software such as applications, and includes various processes according to the purpose of analysis. The analysis process includes, for example, a process of detecting a location of a specific lesion such as a brain tumor, a process of specifying a given anatomical site, a process of measuring a volume of a given anatomical site or a lesion site, a process of measuring a partial pressure of oxygen, and other given processes. The analyzing function 312 is an example of an analyzing unit.

As shown in FIG. 3, the analyzing function 312 includes a first analyzing function 318 and a second analyzing function 319. The first analyzing function 318 is configured to execute a first analysis process for the first medical image to output a first analysis result. The second analyzing function 319 is configured to execute a second analysis process for a second medical image to output a second analysis result.

The determining function 313 is configured to determine, based on the first analysis result output from the first analyzing function 318, whether or not the second analysis process is required as an additional analysis process. The determining function 313 may be configured to determine whether or not the second analysis process is required in consideration of data other than the first analysis result. The determining function 313 is an example of a determining unit.

The establishing function 314 is configured, if it has been determined by the determining function 313 that the second analysis process is required, to establish an image characteristic recommended to be equipped in the second medical image used in the second analysis process in accordance with a processing content of the second analysis process. The “image characteristic” specifically refers to a property of a medical image related to an outer appearance, such as a spatial resolution, an inter-tissue contrast, a slice thickness, a matrix size, and/or a slice position. The spatial resolution, the inter-tissue contrast, the slice thickness, the matrix size, the slice position, etc. will be referred to as “image characteristic parameters”. Also, data denoting an image characteristic will be referred to as “image characteristic data”. The image characteristic may be represented by numerical values, symbols, etc. of the image characteristic parameters, or may be represented by a sentence, a character string, etc. qualitatively expressing the image characteristic parameters. The establishing function 314 is an example of an establishing unit.

The converting function 315 is configured to convert the image characteristic of the second medical image into an image generation condition. The “image generation condition” refers to a reconstruction condition for image reconstruction processing to be executed for generating a medical image equipped with the image characteristic and/or an image processing condition for image processing. The “reconstruction condition” refers to numerical values and/or symbols of various reconstruction parameters of image reconstruction processing, and the “image processing condition” refers to numerical values and/or symbols of various image processing parameters of image processing. The image generation condition is used by the medical imaging apparatus 200 to obtain the second medical image. The converting function 315 is an example of a converting unit.

The communication control function 316 is configured to transmit and receive a variety of data via the communication interface 35 to and from the medical imaging apparatus 200 and the medical image display apparatus 400. As an example, the communication control function 316 transmits, to the medical imaging apparatus 200, the image characteristic and a request for obtaining the second medical image related to the subject. Alternatively, the communication control function 316 may be configured to transmit the first analysis result and the second analysis result to the medical image display apparatus 400. In this case, the medical image display apparatus 400 displays the first analysis result and the second analysis result on display equipment. As another example, the communication control function 316 receives, from the medical imaging apparatus 200, the second medical image obtained by the medical imaging apparatus 200 in response to the obtaining request. Alternatively, the communication control function 316 may be configured to receive the first medical image related to the subject from the medical imaging apparatus 200. The communication control function 316 is an example of a transmission unit and a reception unit.

The display control function 317 is configured to display a variety of data on the display equipment 33.

The storage device 32 is a storage device configured to store various types of data, such as a ROM, a RAM, an HDD, an SSD, an integrated-circuit storage device, or the like. Other than such storage devices, the storage device 23 may be a portable storage medium such as a CD, a DVD, or a flash memory, or a driver configured to read and write various types of information to and from a semiconductor memory device. The storage device 32 may be located within another computer connected via a network to the medical image processing apparatus 300.

The display equipment 33 is configured to display a variety of data. For the display equipment 33, a liquid crystal display, a CRT display, an organic EL display, a plasma display, or any other display may be suitably used. The display equipment 33 may also be a projector.

The input interface 34 is configured to receive various input operations from a user, convert the received input operations into electrical signals, and output them to the processing circuitry 31. Specifically, the input interface 34 is connected to input equipment such as a mouse, a keyboard, a track ball, switches, buttons, a joystick, a touch pad, and/or a touch panel display. The input interface 34 is configured to output an electric signal, in response to an input operation to the input equipment, to the processing circuitry 31. Note that the input equipment connected to the input interface 34 may be provided on another computer connected via a network, etc. The input interface 34 may be a speech recognition device configured to convert an audio signal acquired by a microphone into an instruction signal.

The communication interface 35 includes an NIC for performing a communication connection with external equipment such as the medical imaging apparatus 200, the medical image display apparatus 400, etc. via a network.

A description will be given of an exemplary operation of the medical image processing system 100 according to the present embodiment.

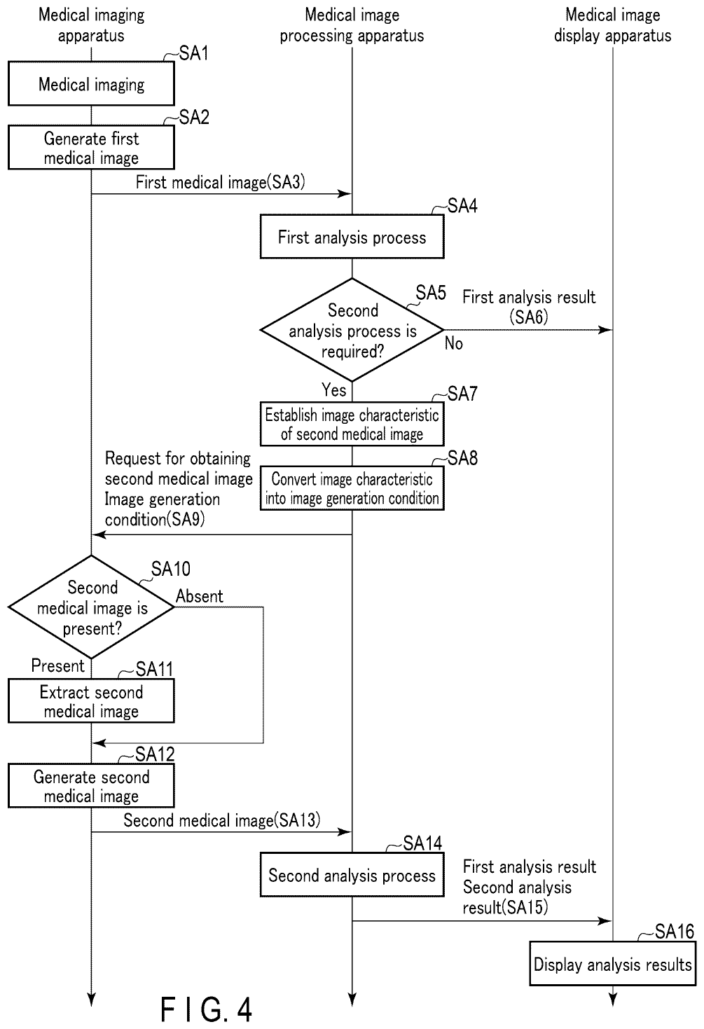

FIG. 4 is a diagram showing a flow of an automatic analysis process by the medical image processing system 100. In the description that follows, it is assumed that the medical imaging apparatus 200 is a magnetic resonance imaging apparatus, that an inspection site of the subject is a head, and that the diagnosis target is a brain tumor.

As shown in FIG. 4, the imaging mechanism 21 of the medical imaging apparatus 200 executes one or more medical imaging for a subject in accordance with an imaging protocol planned in advance (step SA1). In a head MR examination, for example, the imaging protocol may include calibration scanning, T1-weighted imaging, T2-weighted imaging, fluid-attenuated inversion recovery (FLAIR) imaging, diffusion-weighted imaging, and other types of medical imaging. In each medical imaging, raw data related to the subject is acquired by the imaging mechanism 21. The acquired raw data is stored in the storage device 23.

After step SA1, the processing circuitry 22 generates, with the image generating function 227, a medical image from the acquired raw data (step SA2). Medical images are sequentially generated for every medical imaging. The generated medical images are sequentially stored in the storage device 32. Of the medical images sequentially generated by carrying out the imaging protocol, a medical image after a first analysis process is generated as a first medical image.

After step SA2, the processing circuitry 22 transmits, with the communication control function 224, the first medical image to the medical image processing apparatus 300 (step SA3). The medical image processing apparatus 300 receives the first medical image. The received first medical image is obtained by the processing circuitry 31 with the obtaining function 311.

After step SA3, the processing circuitry 31 executes, with the first analyzing function 318, the first analysis process for the received first medical image to output a first analysis result (step SA4).

After step SA4, the processing circuitry 31 determines, with the determining function 313, whether or not a second analysis process is required (step SA5). If it has been determined at step SA5 that the second analysis process is unnecessary (step SA5: NO), the processing circuitry 31 transmits, with the communication control function 316, the first analysis result to the medical image display apparatus 400 (step SA6). The medical image display apparatus 400 receives the first analysis result. Thereafter, the medical image display apparatus 400 displays the received first analysis result (step SA13). A doctor who is a user of the medical image display apparatus 400 makes a diagnosis for a subject by referring to the first analysis result.

On the other hand, if it has been determined at step SA5 that the second analysis process is necessary (step SA5: YES), the processing circuitry 31 establishes, with the establishing function 314, an image characteristic recommended to be equipped in the second medical image and necessary for the second analysis process, in accordance with a processing content of the second analysis process (step SA7). After step SA7, the processing circuitry 31 converts, with the converting function 315, the image characteristic established at step SA7 into an image generation condition based on a rule or through use of a machine learning model (step SA8). It is assumed herein that the medical image processing apparatus 300 and the medical imaging apparatus 200 are from a common manufacturer (vendor). In this case, the processing circuitry 31 is capable of outputting a detailed image generation condition defined by the specification adopted both in the medical image processing apparatus 300 and the medical imaging apparatus 200.

Note that the number of second analysis processes derived from a single first analysis result may be either one or more than one. If there is more than one second analysis process, the image characteristic and the image generation condition are obtained for each of the second analysis processes. Also, the number of image characteristics corresponding to a single second analysis process may be either one or more than one. If there is more than one image characteristic, the image generation condition is obtained for each of the image characteristics.

Hereinafter, three working examples related to the first analysis process (SA4), the determination process as to whether or not the second analysis process is required (SA5), the establishment process of the image characteristic (SA6), and the conversion process to the image generation condition (SA7) will be described. Assume that the first analysis process is a brain tumor detection process in which a spatial distribution (hereinafter referred to as a “probability value map”) of probability values denoting a likelihood of a tumor is calculated based on the first medical image, a tumor region is partitioned from the first medical image based on a comparison between each of the probability values and a first threshold value, and a location of the partitioned tumor region is output. In this case, the first analysis result includes the probability value map, the location of the tumor region, etc. It is assumed that the brain tumor detection process is performed using a deep neural network configured to take head MR images as an input and to output a location of a tumor region.

Working Example 1: The second analysis process according to Working Example 1 has the same processing content as the first analysis process, and is performed to improve the precision of detection of a tumor region, as compared to the first analysis process. Specifically, the second analysis process according to Working Example 1 is the same brain tumor detection process as the first analysis process, and is performed to improve the precision of detection of a brain tumor region, as compared to the first analysis process. The image characteristic recommended to be equipped in the second medical image after the second analysis process is a characteristic of having a high contrast between a normal tissue region and a brain tumor region as compared to the first medical image. Hereinafter, an exemplary operation of Working Example 1 will be described.

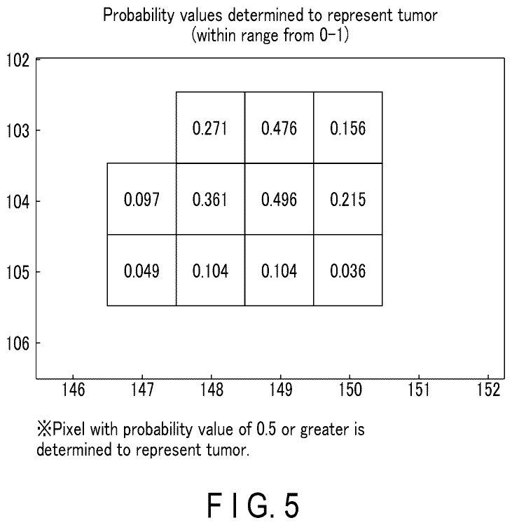

FIG. 5 is a diagram schematically representing a first analysis result according to Working Example 1. The first analysis result shown in FIG. 5 represents a probability value map denoting a likelihood of a brain tumor, in an enlarged view of an image region suspected to be a brain tumor. The numerical value shown in each pixel in FIG. 5 is a probability value. As an example, the probability value is set within a numerical range from 0 to 1. In a brain tumor detection process, a first threshold value is set to 0.5, and a set of pixels having a probability value equal to or greater than 0.5 is partitioned into a brain tumor region. In the case of FIG. 5, the probability value included in the first analysis result is, at maximum, 0.496, which is slightly smaller than the first threshold value determined to represent a brain tumor. If the probability value is slightly smaller than the first threshold value, there is a possibility for a brain tumor, and an additional analysis process (a second analysis process) is performed on an MR image with a higher contrast between the normal tissue region and the tumor region. Hereinafter, an exemplary operation of Working Example 1 will be described.

At step SA5, the processing circuitry 31 determines, if all the probability values included in the probability value map are determined to be smaller than the first threshold value, whether or not a difference between each of the probability values and the first threshold value is smaller than a second threshold value. The processing circuitry 31 determines that the second analysis process is required if the difference is smaller than the second threshold value, and determines that the second analysis process is not required if the difference is larger than the second threshold value. Here, the “probability value” may be a maximum value among the probability values of the pixels included in the probability value map, or may be a mean value, an intermediate value, etc., of the probability values equal to or greater than a third threshold value smaller than the first threshold value.

If it has been determined that the second analysis process is required (SA5: YES), the processing circuitry 31 establishes, at step SA7, a processing content of the second analysis process based on the first analysis result. The processing content of the second analysis process can be established based on a rule. Specifically, for such a rule, a first lookup table (LUT) in which a specific content of the first analysis result is associated with a processing content of the second analysis process is used. The first LUT defines a rule that, if the first analysis result includes the specific content, the second analysis process with the corresponding processing content is carried out. In the case of Working Example 1, the specific content of the first analysis result is that “the difference between the probability value and the first threshold value is smaller than the second threshold value”, and the processing content of the second analysis process is set to a “brain tumor detection process”. Note that, instead of the above-described rule, a machine learning model which has learned a correlation between an input (a specific content of the first analysis result) to and an output (a processing content of the second analysis process) from the first LUT may be used.

After the processing content of the second analysis process is established, the processing circuitry 31 establishes an image characteristic of the second medical image in accordance with the processing content. The image characteristic can be established based on a rule. Specifically, for such a rule, a second LUT in which a processing content of the second analysis process is associated with an image characteristic of the second medical image is used. The second LUT defines a rule that, if the second analysis result is of the corresponding processing content, the second analysis process with the corresponding processing content is carried out. In the case of Working Example 1, the processing content of the second analysis process is a “brain tumor detection process”, and the second medical image is set to have an image characteristic of “having a high contrast between the normal tissue region and the brain tumor region as compared to the first medical image”. Note that, instead of the above-described rule, a machine learning model which has learned a correlation between an input (the processing content of the second analysis process) to the second LUT and an output (the image characteristic of the second medical image) from the second LUT may be used.

Subsequently, the processing circuitry 31 converts the image characteristic into an image generation condition (SA8). The image generation condition includes, in concept, an image reconstruction condition and an image processing condition. Specifically, a T2-weighted image is used as the input image (first medical image) to the brain tumor detection process. To increase the contrast compared to the first medical image, an image processing condition that “an edge enhancement be executed for the brain tumor region”, for example, is established. If an edge enhancement is already applied to the first medical image, it is preferable that an edge intensity, which is a parameter of the edge enhancement, be set to a value higher than that in the first medical image. Alternatively, to increase the contrast compared to the first medical image, an image processing condition that “an image filter be applied”, for example, is established. For such an image filter, it is preferable that an image filter that increases the whiteness of the pixel, in other words, decreases the gradation value, which is an example of the pixel value, be used. If an image filter is already applied to the first medical image, it is preferable that a filter intensity, which is a parameter of the image filter, be set to a value higher than that in the first medical image.

Working Example 2: The second analysis process according to Working Example 2 is performed to obtain additional information that cannot be obtained from the first analysis process. Specifically, the second analysis process is a feeding vessel detection process performed to obtain additional information as to whether or not a feeding vessel to a tumor is present, which cannot be obtained by the first analysis process. The image characteristic recommended to be equipped in the second medical image after the second analysis process is a characteristic of having a high contrast between the blood flow region and other regions as compared to the first medical image.

As the partial pressure of oxygen increases from 0 mmHg, which represents an anoxic condition, the radiation sensitivity increases; the relative value of the radiation sensitivity reaches 2.0 at a partial pressure of oxygen of approximately 3 mmHg, and plateaus at 3.0 at a partial pressure of oxygen of approximately 30 mmHg. That is, from a tumor that is in a near-anoxic condition and thus has a low radiation sensitivity, it is difficult to expect a radiation therapy effect (the effect of tumor shrinkage as a result of radiation). From a tumor to which a feeding vessel is present and which thus has a relatively high partial pressure of oxygen and a relatively high radiation sensitivity, a radiation therapy effect can be expected (Al-Waili, Noori S., et al. “Hyperbaric oxygen and malignancies: a potential role in radiotherapy, chemotherapy, tumor surgery and phototherapy.” Medical science monitor 11.9 (2005): RA279.). Hereinafter, an exemplary operation of Working Example 2 will be described.

At step SA5, the processing circuitry 31 determines whether or not some or all of the probability values included in a probability value map are greater than a first threshold value. If some or all of the probability values are greater than the first threshold value, it means that a tumor region has been detected. The processing circuitry 31 determines that the second analysis process is required if a tumor region has been detected, and that the second analysis process is not required if a tumor region is not detected.

If it has been determined that the second analysis process is required (SA5: YES), the processing circuitry 31 establishes, at step SA7, a processing content of the second analysis process based on the first analysis result and whether or not prediction of the radiation therapy effect is required. The processing content of the second analysis process can be established based on a rule. Specifically, for such a rule, a first LUT in which a specific content of the first analysis result and whether or not prediction of the radiation therapy effect is required are associated with a processing content of the second analysis process is used. The first LUT defines a rule that, if the first analysis result includes the specific content and prediction of the radiation therapy effect is required, the second analysis process with the corresponding processing content is carried out. In the case of Working Example 2, the specific content of the first analysis result is that “a tumor region has been detected by the brain tumor detection process”. The processing content of the second analysis process is set to a “feeding vessel detection process”. Whether or not prediction of the radiation therapy effect is required may be specified by the user via the input interface 34, or may be linked with patient information related to the target subject. Note that, instead of the above-described rule, a machine learning model which has learned a correlation between an input (a specific content of the first analysis result) to and an output (a processing content of the second analysis process) from the first LUT may be used.

After the processing content of the second analysis process is established, the processing circuitry 31 establishes an image characteristic of the second medical image in accordance with the processing content of the second analysis process. The image characteristic can be established based on a rule. Specifically, for such a rule, a second LUT in which a processing content of the second analysis process is associated with an image characteristic of the second medical image is used. The second LUT defines a rule that, if the second analysis result is the corresponding processing content, the second analysis process with the corresponding processing content is carried out. In the case of Working Example 2, the processing content of the second analysis process is a “feeding vessel detection process”, and the second medical image is set to have an image characteristic of “having a high contrast between the blood flow region and the other regions as compared to the first medical image”. Note that, instead of the above-described rule, a machine learning model which has learned a correlation between an input (the processing content of the second analysis process) to the second LUT and an output (the image characteristic of the second medical image) from the second LUT may be used.

Next, the processing circuitry 31 converts the image characteristic into an image generation condition (step SA8). Specifically, an MR image (a blood flow image) in which blood flow components to the brain tumor are enhanced by contrast or non-contrast imaging is used as the input image (first medical image) to the feeding vessel detection process. As a non-contrast blood flow image, an arterial spin labelling (ASL) image may also be employed. To increase the contrast of the blood flow region, an image processing condition that “an edge enhancement be executed for the blood flow region”, for example, may be established. Alternatively, to increase the contrast of the blood flow region compared to the first medical image, an image processing condition that “an image filter be applied”, for example, is established.

Working Example 3: The second analysis process according to Working Example 3 is performed to detect another disease that is accidentally found in the first analysis process. Specifically, the second analysis process according to Working Example 3 is a hippocampal volume measuring process carried out to detect Alzheimer's disease accidentally found in the first analysis process. The image characteristic recommended to be equipped in the second medical image after the second analysis process is a characteristic of having a high spatial resolution as compared to the first medical image.

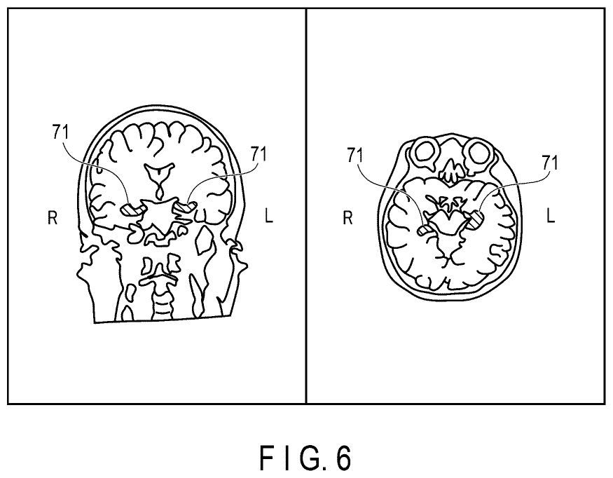

FIG. 6 is a diagram showing an example of head MR images. FIG. 6 shows a coronal cross-sectional image at the left, and shows an axial cross-sectional image at the right. As shown in FIG. 6, head MR images are displayed as the first analysis result of the first analysis process. Due to the presence of the hippocampus, a hippocampal region 71 may appear, depending on the slice position, in a head MR image displayed as the first analysis result. If a hippocampal volume, which tends to shrink with age, is smaller than a standard volume for the age of the subject, there is a possibility that Alzheimer's disease is present in the patient. Hereinafter, an exemplary operation of Working Example 3 will be described.

At step SA5, the processing circuitry 31 determines whether or not a second analysis process, which is a hippocampal volume measuring process, is required. As an example, the processing circuitry 31 determines, based on whether or not there is a possibility of the presence of Alzheimer's disease, whether or not a second analysis process is required. Whether or not there is a possibility of the presence of Alzheimer's disease may be specified by the user via the input interface 34, or linked with patient information related to the target subject, or may be estimated from the patient information using a given algorithm such as machine learning. The processing circuitry 31 determines that, if there is a possibility of the presence of Alzheimer's disease, the second analysis process is required, and that, if there is no possibility of the presence of Alzheimer's disease, the second analysis process is not required.

After determining that the second analysis process is required, the processing circuitry 31 establishes an image characteristic of the second medical image in accordance with a processing content of the second analysis process. The image characteristic can be established based on a rule. Specifically, for such a rule, a second LUT in which a processing content of the second analysis process is associated with an image characteristic of the second medical image is used. The second LUT defines a rule that, if the second analysis result is the corresponding processing content, the second analysis process with the corresponding processing content is carried out. In the case of Working Example 3, the processing content of the second analysis process is a “hippocampal volume measuring process”, and the second medical image is set to have an image characteristic of “having a high spatial resolution as compared to the first medical image”. Note that, instead of the above-described rule, a machine learning model which has learned a correlation between an input (the processing content of the second analysis process) to and an output (the image characteristic of the second medical image) from the second LUT may be used.

Next, the processing circuitry 31 converts the image characteristic into an image generation condition. Specifically, a three-dimensional T1-enhanced image with a high spatial resolution is used as the input image (first medical image) to the hippocampal volume measuring process. To increase the contrast of the hippocampal region, an image processing condition that “an edge enhancement be executed for the hippocampal region”, for example, may be established. Alternatively, to increase the contrast of the hippocampal region compared to the first medical image, an image processing condition that “an image filter be applied”, for example, is established.

This completes the description of the working examples. Note that which of the processes of Working Examples 1 to 3 is to be performed on the first analysis result of the brain tumor detection process can be freely set. For the first analysis result, the processing circuitry 31 may carry out either a given one or two or all of Working Examples 1 to 3.

As shown in FIG. 4, after step SA8, the processing circuitry 31 transmits, with the communication control function 3161, an obtaining request for the second medical image, as well as the image characteristic and the image generation condition, to the medical imaging apparatus 200 (step SA9). The medical imaging apparatus 200 receives the obtaining request for the second medical image, the image characteristic, and the image generation condition.

After step SA9, the processing circuitry 22 of the medical imaging apparatus 200 obtains, with the image obtaining function 222, the second medical image equipped with the received image characteristic, without performing additional medical imaging (steps SA10 to SA12). Specifically, the processing circuitry 22 determines whether or not the second medical image is present in the storage device 23 (step SA10). As an example, with the retrieving function 226, the processing circuitry 22 displays, on the display equipment 24, a list of image characteristics and/or image generation conditions related to medical images stored in the storage device 23. The user specifies, via the input interface 25, one of the medical images as the second medical image from the list. If one of the medical images is specified, the processing circuitry 22 determines that the second medical image is present. If none of the medical images is specified, the processing circuitry 22 determines that the second medical image is not present (absent).

If it has been determined that the second medical image is present (step SA10: Present), the processing circuitry 22 extracts, with the retrieving function 226, the second medical image from the storage device 23 (step SA11). Thereby, the second medical image is obtained.

If it has been determined that the second medical image is not present (step SA10: Absent), the processing circuitry 22 generates, with the image generating function 227, the second medical image (step SA12). Specifically, the processing circuitry 22 reads, from the storage device 23, raw data necessary for generating the second medical image, and generates, from the read raw data, the second medical image based on the image generation condition received at step SA9. As an example, the processing circuitry 22 executes image reconstruction for the raw data in accordance with the reconstruction condition included in the image generation condition, and generates a medical image. If only the reconstruction condition is defined as the image generation condition, the medical image is reconstructed as the second medical image. If the image processing condition is defined as the image generation condition in addition to the reconstruction condition, the processing circuitry 22 executes image reconstruction processing for the raw data based on the reconstruction condition included in the image generation condition, image processing for the medical image based on the image processing condition included in the image generation condition, and generates the second medical image.

After step SA11 or SA12, the processing circuitry 22 transmits, with the communication control function 224, the second medical image to the medical image processing apparatus 300 (step SA13). The medical image processing apparatus 300 receives the second medical image. The received second medical image is obtained by the processing circuitry 31 with the obtaining function 311.

After step SA13, the processing circuitry 31 executes, with the second analyzing function 319, the second analysis process for the received second medical image to output a second analysis result (step SA14). The processing circuitry 31 transmits, with the communication control function 316, the first analysis result output at step SA4 and the second analysis result output at step SA14 to the medical image display apparatus 400 (step SA15). The medical image display apparatus 400 receives the first analysis result and the second analysis result.

After step SA15, the medical image display apparatus 400 displays the received first analysis result and second analysis result on display equipment (step SA16). Display formats of the first analysis result and the second analysis result can be freely set. As an example, the medical image display apparatus 400 displays the first analysis result and the second analysis result side by side on a single screen. At this time, the medical image display apparatus 400 applies, to the second analysis result, a visual effect indicating that the second analysis result is a result of an additional analysis process. A doctor who is a user of the medical image display apparatus 400 makes a diagnosis for the subject by referring to both the first analysis result and the second analysis result.

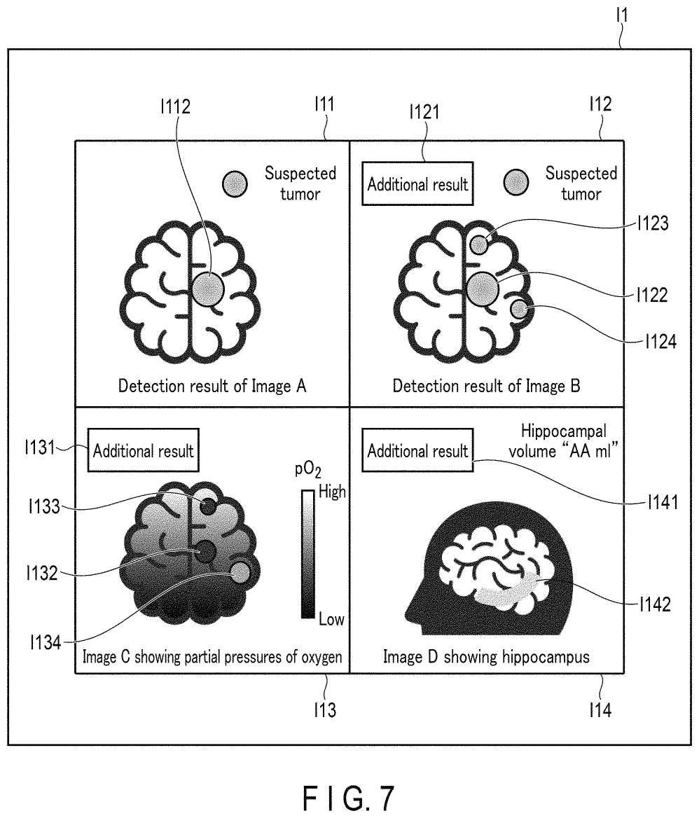

FIG. 7 is a diagram showing an example of a display screen I1 of a first analysis result I11 and second analysis results I12, I13, and I14. As shown in FIG. 7, the medical image display apparatus 400 displays the first analysis result I11 and the second analysis results I12, I13, and I14 side by side on a single screen. FIG. 7 illustrates the display screen I1 corresponding to the above-described working example. An image A, which is an analysis result of the brain tumor detection process, is displayed as the first analysis result I11. In the image A, a detected tumor region I112 is displayed in a visually enhanced manner by means of coloring, etc.

An image B, which is an analysis result of the brain tumor detection process according to Working Example 1, is displayed as the second analysis result I12, as shown in FIG. 7. In the image B, detected tumor regions I122, I123, and I124 are displayed in a visually enhanced manner by means of coloring, etc. Since the image B is expected to detect a tumor region with a higher contrast and with a higher precision than the image A, tumor regions I123 and I124, which have not been detected in the image A, may be displayed in an enhanced manner in the image B, as well as the tumor region I122 detected in the image A. By displaying the first analysis result I11 and the second analysis result I12 side by side, the first analysis result I11 and the second analysis result I12 with different inter-tissue contrasts can be visually compared.

An image C, which is an analysis result of the feeding vessel detection process according to Working Example 2, is displayed as the second analysis result I13, as shown in FIG. 7. The image C, to which color values are assigned according to the partial pressure of oxygen (pO<4311>2</4311>), expresses a spatial distribution of partial pressures of oxygen. A tumor region I134 through which a feeding vessel flows and thus a large amount of oxygen is carried tends to have a high partial pressure of oxygen. Tumor regions I132 and I133 through which a feeding vessel does not flow tend to not have a high partial pressure of oxygen. A low partial pressure of oxygen, which tends to cause a low radiation sensitivity, means that the radiation therapy effect on the tumor region is low. That is, the image C can be said to express a spatial distribution of the radiation therapy effect. By observing the image C, the user can estimate the radiation therapy effect on the detected tumor regions I132, I133, and I134.

An image D, which is an analysis result of the hippocampal volume measuring process according to Working Example 3, is displayed as the second analysis result I14. In the image D, a hippocampal region I142 whose volume has been measured is displayed in a visually enhanced manner by means of coloring, etc. By enhancing the hippocampal region I142 in the image D, which has a higher spatial resolution than the image A, it is possible to provide, to the user, the hippocampal region I142 detected with a high precision. Also, a numerical value denoting a measured volume, such as “AA ml”, of the hippocampal region I142 may be displayed as the second analysis result I14. By displaying the hippocampal region I142 in an enhanced manner or displaying the numerical value of the measured volume, the diagnosis of the brain tumor can be used as an opportunity to determine the possibility of the presence of Alzheimer's disease.

By displaying the first analysis result I11 and the second analysis results I12, I13, and I14 in parallel on a single screen, as shown in FIG. 7, it is possible to comprehensively provide information necessary for diagnosis of the subject. At this time, it is preferable that the medical image display apparatus 400 appends, to the second analysis results I12, I13, and I14, flags (hereinafter referred to as “additional analysis flags) I121, I131, and I141 indicating that they are results of an additional analysis process. By appending the additional analysis flags I121, I131, and I141, it is possible to explicitly show that the second analysis results I12, I13, and I14 are information different from the analysis result of the first analysis process, which is executed by default. It is thereby possible to provide the second analysis results I12, I13, and I14, while reducing the doctor's confusion.

After step SA16, the automatic analysis process by the medical image processing system 100 is completed.

As described above, the medical image processing system 100 according to the present embodiment includes the medical image processing apparatus 300 and the medical imaging apparatus 200, which are communicably connected to each other. The medical image processing apparatus 300 realizes the communication control function 316, the analyzing function 312, the determining function 313, and the establishing function 314. The communication control function 316 receives a first medical image related to the subject from the medical imaging apparatus 200. The analyzing function 312 executes a first analysis process for the first medical image to output a first analysis result. The determining function 313 determines, based on the first analysis result, whether or not a second analysis process is required as an additional analysis process. If it has been determined that the second analysis process is required, the establishing function 314 establishes an image characteristic recommended to be equipped in a second medical image in accordance with a processing content of the second analysis process.

With the above-described configuration, it is possible to automatically establish the image characteristic recommended to be provided in the second medical image and whether or not the second analysis process is required as an additional analysis process, thus allowing the second medical image to be specified with ease. In addition, with the automatic analysis process shown in FIG. 4, it is possible to obtain the second medical image by utilizing data already present in the medical imaging apparatus 200 in accordance with an image processing condition based on the image characteristic, thus eliminating the necessity for additional medical imaging. It is therefore possible to obtain the second medical image without placing a strain on the healthcare professional or the patient due to additional medical imaging.

The automatic analysis process shown in FIG. 4 is merely an example, and various steps may be deleted, added, and/or modified. Hereinafter, several modifications according to the present embodiment will be described.

### Modification 1

In the automatic analysis process described above with reference to FIG. 4, the medical imaging apparatus 200 is configured, in response to the obtaining request for the second medical image, to execute the process of obtaining the second medical image (SA10 to SA12) with no conditions. The medical imaging apparatus 200 according to Modification 1 is configured to confirm with the user, such as a radiographer, whether or not to execute the process of obtaining the second medical image. Hereinafter, processing according to Modification 1 will be described.

Upon receiving, at step SA9, the obtaining request for the second medical image, the processing circuitry 22 of the medical imaging apparatus 200 displays, with the display control function 225, a window (hereinafter referred to as a “confirmation window) for allowing the user to confirm whether or not to accept provision of the second medical image on the display equipment 24.

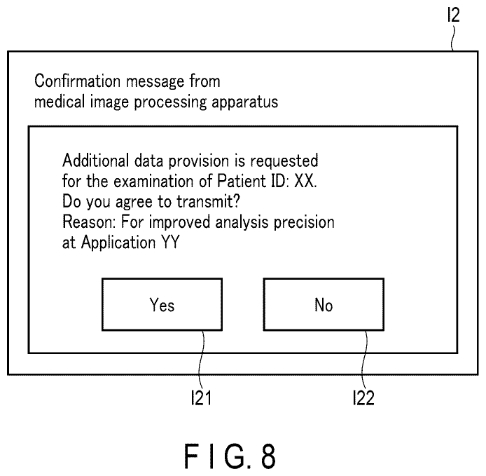

FIG. 8 is a diagram showing a display example of a confirmation window I2. As shown in FIG. 8, the confirmation window I2 displays a message for allowing the user of the medical imaging apparatus 200 to confirm whether or not to accept provision of the second medical image, such as “Additional data provision is requested for the examination of Patient ID: XX. Do you agree to transmit?”. Note that the “additional data” means the second medical image. At this time, a character string denoting a reason for requesting the provision of the second medical image, such as “Reason: For improved analysis precision at Application YY” may be displayed alongside the above-described message. The display content related to the reason, such as the application name of the second analysis process, can be provided by the medical image processing apparatus 300.

As shown in FIG. 8, a GUI button (hereinafter referred to as “Yes” button) I21 for allowing the user to express the intention to agree with the provision and a GUI button (hereinafter referred to as “No” button) I22 for allowing the user to express the intention to disagree with the provision are disposed on the confirmation window I2. The user determines, by looking at the confirmation window I2, whether or not to agree with the provision of the second medical image. If, for example, high-load processing such as medical imaging is intermittently planned in the medical imaging apparatus 200 after obtainment of the obtaining request, or if it has been determined that the second analysis process is unnecessary for a clinical reason or the like, the user determines to disagree with the provision of the second medical image, and depresses the “No” button I22 via the input interface 25. On the other hand, if an idle time is set in the medical imaging apparatus 200, or if it has been determined that the second analysis process is necessary, the user determines to agree with the provision of the second medical image, and depresses the “Yes” button I21 via the input interface 25.

If the “Yes” button I21 is depressed, the processing circuitry 22 executes processing from step SA10 to SA13 shown in FIG. 4. If the “No” button I22 is depressed, the processing circuitry 22 does not execute the processing from step SA10 to SA13, and transmits, with the communication control function 224, a signal (hereinafter referred to as a “disagreement signal”) indicating disagreement with the transmission of the second medical image to the medical image processing apparatus 300. If the disagreement signal is received, the processing circuitry 31 of the medical image processing apparatus 300 does not execute the second analysis process (SA14), and transmits, with the communication control function 316, the first analysis result to the medical image display apparatus 400, and the medical image display apparatus 400 displays the first analysis result on display equipment.

As described above, the medical imaging apparatus 200 according to Modification 1 executes the process of obtaining the second medical image only in the case where an intention to agree with the provision of the second medical image has been expressed. It is thereby possible to reduce unnecessary image generation processing, transfer of the second medical image, the second analysis process, etc.

### Modification 2

In the automatic analysis process described above with reference to FIG. 4, the medical image processing apparatus 300 and the medical imaging apparatus 200 are from an identical manufacturer, and the medical image processing apparatus 300 is configured to convert the image characteristic into the image generation condition. According to Modification 2, the medical image processing apparatus 300 and the medical imaging apparatus 200 are from different manufacturers, and the medical imaging apparatus 200 is configured to convert the image characteristic into the image generation condition. Hereinafter, a processing example of the medical image processing system 100 according to Modification 2 will be described.

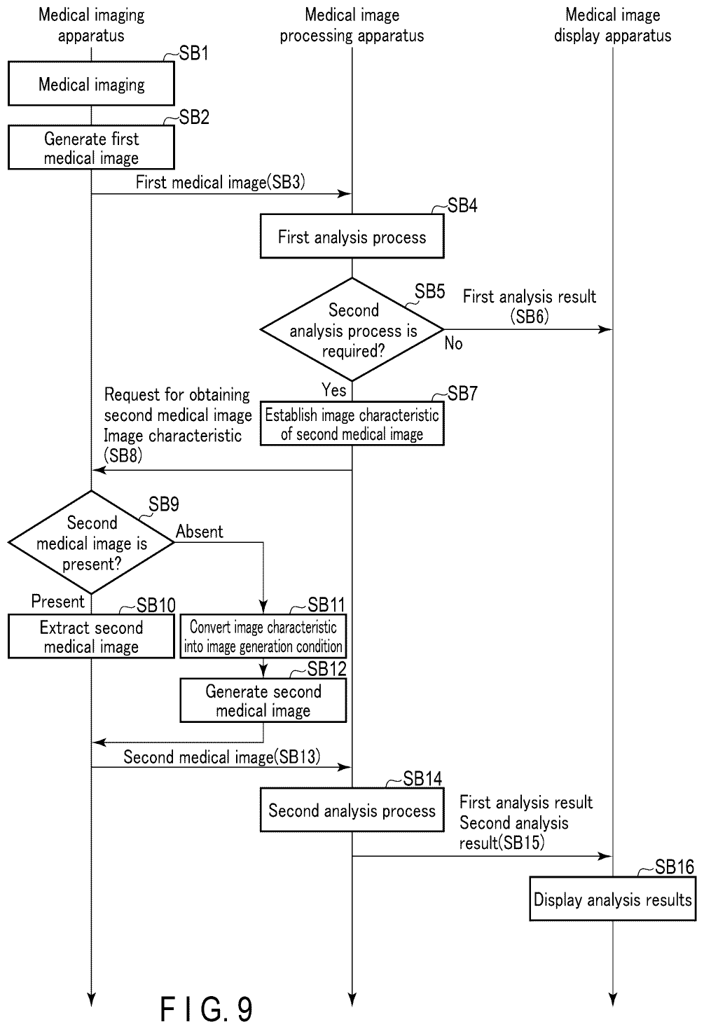

FIG. 9 is a diagram showing a flow of an automatic analysis process by the medical image processing system 100 according to Modification 2. Steps SB1 to SB7 shown in FIG. 9 are identical to steps SA1 to SA7, respectively, shown in FIG. 4, and will not be described herein.

After step SB7, with the communication control function 316, the processing circuitry 31 transmits, to the medical imaging apparatus 200, the image characteristic and an obtaining request for the second medical image (step SB8). The medical imaging apparatus 200 receives the image characteristic and the obtaining request for the second medical image.

After step SB8, the processing circuitry 22 of the medical imaging apparatus 200 determines, with the image obtaining function 222, whether or not the second medical image is present in the storage device 23 (step SB9). As an example, the processing circuitry 22 displays, with the retrieving function 226, a list of image characteristics related to medical images stored in the storage device 23 on the display equipment 24, to allow a user to specify, via the input interface 25, one of the medical images from the list as the second medical image. If one of the medical images is specified, the processing circuitry 22 determines that the second medical image is present. If none of the medical images is specified, the processing circuitry 22 determines that the second medical image is not present (absent).

If it has been determined that the second medical image is present (step SB9: Present), the processing circuitry 22 extracts, with the retrieving function 226, the second medical image from the storage device 23 (step SB10).

If it has been determined that the second medical image is not present (step SB9: Absent), the processing circuitry 22 converts, with the converting function 315, the image characteristic received at step SB8 into an image generation condition defined by a specification adopted by the medical imaging apparatus 200 (step SB11). The conversion from the image characteristic to the image generation condition can be executed based on a rule using an LUT in which an image characteristic is associated with an image generation condition defined by a specification adopted by the medical imaging apparatus 200, or can be executed using a machine learning model trained to take an image characteristic as an input and output an image generation condition defined by a specification adopted by the medical imaging apparatus 200.

After step SB11, the processing circuitry 22 generates, with the image generating function 227, the second medical image (step SB12). Step SB12 is similar to step SA12 in FIG. 4.

After step SB10 or SB12, the processing circuitry 22 transmits, with the communication control function 224, the second medical image to the medical image processing apparatus 300 via the communication interface 26 (step SB13). The medical image processing apparatus 300 receives the second medical image. The received second medical image is obtained by the processing circuitry 31 with the obtaining function 311. Thereafter, a second analysis process (SB14), transmission of a first analysis result and a second analysis result (at SB15), and displaying of the analysis results (SB16) are performed. Steps SB14, SB15, and SB16 are similar to steps SA14, SA15, and SA16, respectively.

After step SB16, the automatic analysis process by the medical image processing system 100 according to Modification 2 is completed.

According to Modification 2, even if the medical imaging apparatus 200 and the medical image processing apparatus 300 are from different manufacturers, by allowing the medical imaging apparatus 200 to execute conversion from an image characteristic to an image generation condition, it is possible to obtain, with the medical imaging apparatus 200, the second medical image equipped with the image characteristic.

### Modification 3

The medical image processing system 100 according to Modification 3 is configured, in the case of issuing an obtaining request for a plurality of second medical images, to set priorities to the plurality of second medical images. In Modification 3, a situation is assumed where a plurality of second medical images are requested for a single second analysis process. Hereinafter, a processing example of the medical image processing system 100 according to Modification 3 will be described.

If there are a plurality of second medical images, the processing circuitry 22 of the medical imaging apparatus 200 obtains, with the image obtaining function 222, the second medical images in accordance with priorities assigned based on whether or not each of the second medical images is obtainable and a time required to obtain each of the second medical images. Specifically, the processing circuitry 22 applies priorities to a plurality of second medical images based on whether or not each of the second medical images is obtainable and a time required to obtain each of the second medical images. The processing circuitry 22 is capable of calculating obtainability information as to whether or not the second medical image is obtainable based on, for example, whether or not the second medical image is present in the storage device 23, and if the second medical image is not present in the storage device 23, whether or not raw data necessary for generating the second medical image is present in the storage device 23. Also, the processing circuitry 22 is capable of calculating a required obtainment time, which is a time required for obtaining the second medical image, based on, for example, a time required to read the second medical image from the storage device 23 if the second medical image is present in the storage device 23, and a standard time, etc., required to generate the second medical image from raw data if the second medical image is not present in the storage device 23. It is preferable that the processing circuitry 22 set a higher priority to a second medical image that is obtainable than a second medical image that is not obtainable. It is also preferable that the processing circuitry 22 set a higher priority to a second medical image with a shorter required obtainment time.

The processing circuitry 22 may allow the user to manually establish the priority to be applied to the second medical image. For example, the processing circuitry 22 displays, on the display equipment 24, a list of second medical images related to the obtainability information and the required obtainment time. By looking at the displayed list, the user establishes priorities to be applied to the respective second medical images. Note that the processing circuitry 22 may display the image characteristics, the image generation conditions, and the processing content of the second analysis process in a list, to allow the user to establish the priorities in view of the displayed information. The processing circuitry 22 applies the priorities input by the user via the input interface 25 to the respective second medical images.

After the priorities are applied to the second medical images, the processing circuitry 22 obtains the second medical images in descending order of priorities (SA11 to SA12 and SB10 to SB12). The obtained second medical images are sequentially transmitted to the medical image processing apparatus 300, where the second analysis process is executed. Note that the processing circuitry 22 may be configured to obtain only second medical images with priorities equal to or greater than a threshold value. It is thereby possible to reduce, for example, a load on the medical imaging apparatus 200 caused by the process of obtaining second medical images with lower priorities, or a load on the medical image processing apparatus 300 caused by the second analysis process.

### Modification 4

The medical image processing system 100 according to Modification 4 is configured to avoid execution of the process of determining whether or not the second analysis process is required on the second medical image (SA5). Specifically, the processing circuitry 22 of the medical imaging apparatus 200 applies, to the second medical image obtained with the image obtaining function 222, a flag (hereinafter referred to as an “additional image flag”) designating the second medical image. The additional image flag is digital data for identifying that the obtained image is a second medical image, in other words, a medical image to be subjected to the second analysis process. The second medical image with the additional image flag is transmitted to the medical image processing apparatus 300.

The processing circuitry 31 of the medical image processing apparatus 300 does not execute, on the second medical image with the additional image flag, the process of determining whether or not an additional analysis process is required. In other words, the process of determining the image characteristic (SA7), the process of converting the image characteristic to the image generation condition (SA8), and the process of obtaining the second medical image (SA9 to SA13) are not executed for the second medical image with the additional image flag. By avoiding an event where steps SA5 to SA13 are repeated, it is possible to reduce the load and the processing time required for unnecessary processing.

As described in the above embodiment, the second medical image with the additional image flag is subjected to the second analysis process to be carried out by the second analyzing function 319. An additional image flag is also applied to the second analysis result output from the second analysis process. The medical image display apparatus 400 displays the second analysis result with the additional image flag by setting analysis flags, as shown in FIG. 7.

Repeating the process of determining whether or not the second analysis process is required a predetermined number of times may be permitted. In this case, the processing circuitry 22 of the medical imaging apparatus 200 applies, to the additional image flag, numerical value information denoting the number of repetitions of the process of determining whether or not the second analysis process is required. The processing circuitry 31 of the medical image processing apparatus 300 refers to the number of repetitions applied to the additional image flag of the second medical image, and determines whether or not the number of repetitions is equal to or smaller than a threshold value. If the number of repetitions is equal to or smaller than the threshold value, the processing circuitry 31 executes the second analysis process on the second medical image, and executes the process of determining whether or not the second analysis process is required. If the number of repetitions is not equal to or smaller than the threshold value, the processing circuitry 31 does not execute, on the second medical image, the process of determining whether or not the second analysis process is required, and executes the second analysis process. It is thereby possible to avoid an event where steps SA5 to SA13 are repeated more than a predetermined number of repetitions, thus reducing the load and processing time required for unnecessary processing.

### Modification 5

According to Modification 5, the medical image processing apparatus 300 is configured to execute the second analysis process only in the case where the second medical image received from the medical imaging apparatus 200 is an expected image. Specifically, processing circuitry 31 of the medical image processing apparatus 300 determines whether or not to adopt the second medical image received from the medical imaging apparatus 200. For example, the processing circuitry 31 may calculate a given image quality evaluation index value of the second medical image, and establish whether or not to adopt the second medical image according to whether or not the calculated image quality evaluation index value exceeds a threshold value. Alternatively, whether or not to adopt the second medical image may be specified by a user via the input interface 34, etc. The processing circuitry 31 executes the second analysis process on the second medical image if it has been determined to adopt the second medical image, and does not execute the second analysis process on the second medical image if it has been determined not to adopt the second medical image. It is thereby possible to avoid unnecessary execution of the second analysis process, thus reducing the overall processing time for the automatic analysis process.

### Modification 6

The first analysis process according to Modification 6 is an analysis process (hereinafter referred to as a “common analysis process”) included in each of a plurality of applications and common to all of the plurality of applications. According to Modification 6, the second analysis process is an analysis process (hereinafter referred to as a “non-common analysis process”) included in each of the plurality of applications and not common to the plurality of applications. The processing circuitry 31 of the medical image processing apparatus 300 is configured to establish the image characteristic in accordance with the non-common analysis process for some or all of the plurality of applications.

It is assumed, as an example, that an application A, an application B, and an application C execute a brain tumor detection process as a common analysis process. Assume that the application A does not include a non-common analysis process, that the application B includes a brain tumor volume measuring process as a non-common analysis process, and that the application C includes a feeding vessel detection process as a non-common analysis process.

The processing circuitry 31 according to Modification 6 is configured, in the first analysis process (SA4), to execute a brain tumor detection process of each of the applications A, B, and C on a first medical image. As an example, a case is assumed where a brain tumor has been detected only by a brain tumor detection process of the application B. In this case, the processing circuitry 31 establishes, in the image characteristic establishing process (SA7), the image characteristic of the second medical image by performing, as the second analysis process, the brain tumor volume measuring process, which is the non-common analysis process of the application B. Considering, from a clinical standpoint, that a brain tumor should be detected by the application C, as well as the application B, the processing circuitry 31 may be configured to establish, in the image characteristic establishing process (SA7), the image characteristic of the second medical image by performing, as the second analysis process, the feeding vessel detection process, which is the non-common analysis process of the application C. The processing circuitry 31 may also be configured to establish, in the image characteristic establishing process (SA7), the image characteristic of the second medical image by performing, as the second analysis process, a non-common analysis process of another application D. If, for example, the application D is an application for detecting the presence of Alzheimer's disease, the non-common analysis process of the application D is a hippocampal region volume measuring process. In this case, the processing circuitry 31 may be configured to establish, in the image characteristic establishing process (SA7), the image characteristic of the second medical image by performing, as the second analysis process, the hippocampal region volume measuring process of the application D.

### Modification 7

In the medical image processing system 100 according to the above-described embodiment, the medical imaging apparatus 200 is configured to obtain the second medical image. However, the configuration of the present embodiment is not limited thereto. In the medical image processing system 100 according to Modification 7, the medical image processing apparatus 300 is configured to generate the second medical image based on the image generation condition.

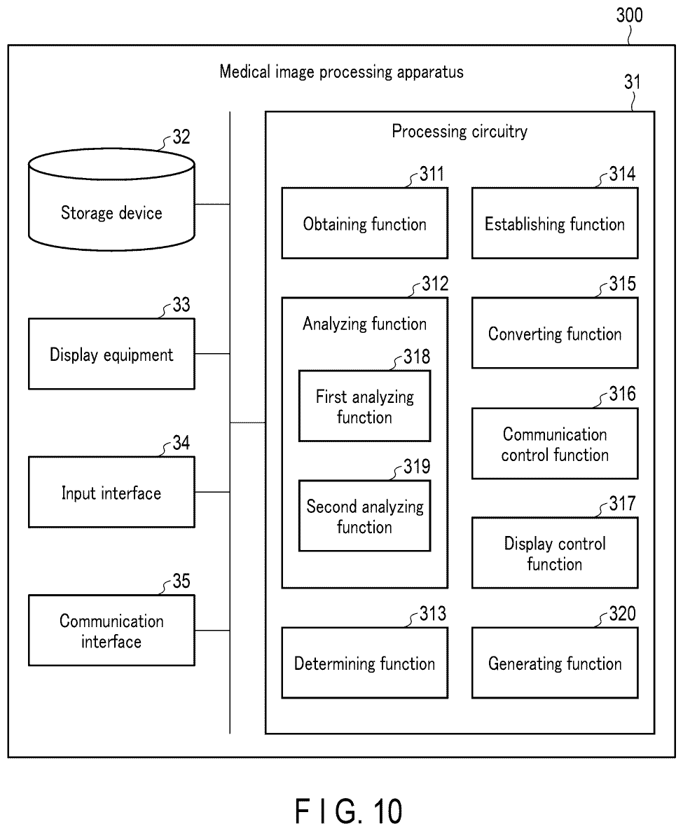

FIG. 10 is a diagram showing a configuration example of the medical image processing apparatus 300 according to Modification 7. As shown in FIG. 10, the processing circuitry 31 of the medical image processing apparatus 300 is configured to realize a generating function 320 in addition to the functions 311 to 319. The generating function 320 is configured to generate the second medical image from the first medical image based on the image generation condition obtained by the converting function 315.

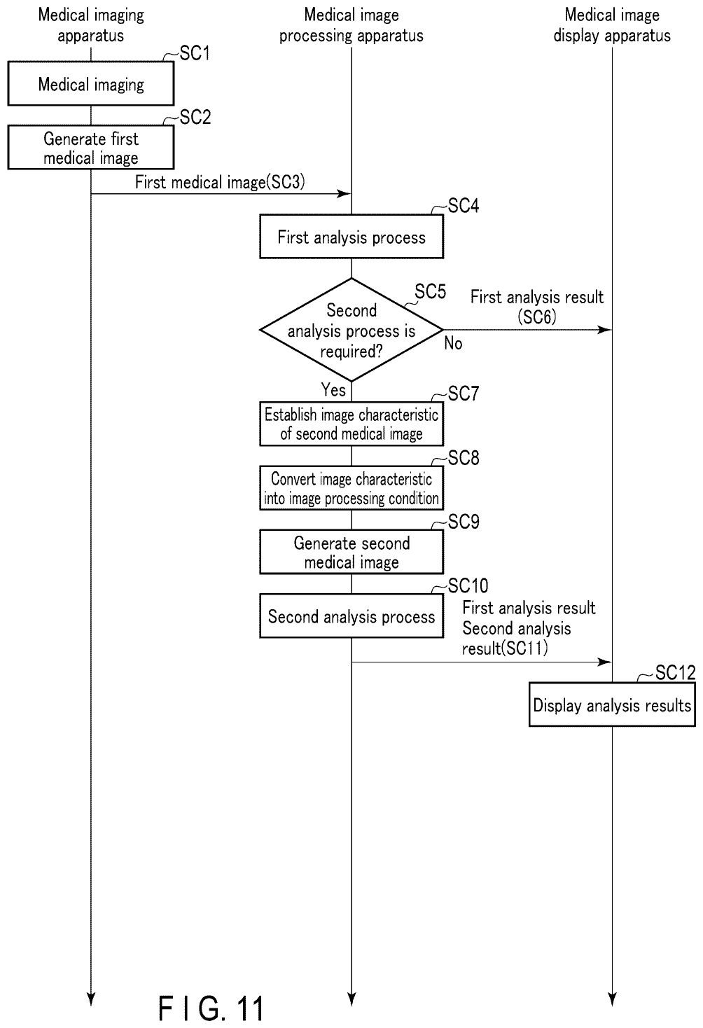

FIG. 11 is a diagram showing a flow of an automatic analysis process by the medical image processing system 100 according to Modification 7. Steps SC1 to SC7 shown in FIG. 11 are identical to steps SA1 to SA7, respectively, shown in FIG. 4, and will not be described herein.

After step SC7, the processing circuitry 31 converts, with the converting function 315, the image characteristic established at step SC7 into an image processing condition defined by a specification adopted by the medical image processing apparatus 300 (step SC8). In Modification 7, the second medical image is generated by an available method even if raw data is not present in the medical image processing apparatus 300. Specifically, the second medical image is generated from the first medical image already supplied to the medical image processing apparatus 300. At step SC8, the processing circuitry 31 outputs the image processing condition for generating the second medical image from the first medical image.

After step SC8, the processing circuitry 31 generates, with the generating function 320, the second medical image from the first medical image based on the image processing condition (step SC9). As an example, in the case of decreasing a slice thickness for improved precision, a second slice thickness smaller than the first slice thickness of the first medical image is output as the image characteristic, and an image processing parameter for realizing the second slice thickness is output as the image processing condition. In this case, the processing circuitry 31 carries out a reslicing process on the first medical image based on the image processing condition, and generates the second medical image having the second slice thickness.

As an example, in the case of increasing a matrix size for improved precision, a second matrix size larger than a first matrix size of the first medical image is output as the image characteristic, and an image processing parameter for realizing the second matrix size is output as the image processing condition. In this case, the processing circuitry 31 carries out zero padding on the first medical image based on the image processing condition, and generates the second medical image having the second matrix size.

As another example, in the case of adding, in addition to the first medical image in a first cross section, a medical image in another (second) cross section for improved precision, the second cross section different from the first cross section is output as the image characteristic, and an image processing parameter for realizing the second cross section is output as the image processing condition. It is assumed, for example, that the first cross section is an axial cross section, and that the second cross section is a sagittal cross section. In the present example, it is assumed that volume data to be formed into an axial cross-sectional image is supplied from the medical imaging apparatus 200 to the medical image processing apparatus 300 at step SA13, etc. In this case, an image processing parameter for generating a sagittal cross-sectional image from the volume data is established as the image processing condition. The processing circuitry 31 carries out an MPR process on the volume data based on the image processing condition, and generates the sagittal cross-sectional image (second medical image).

As another example, in the case of adding, in addition to a contrast image, a non-contrast image for improved precision, the contrast image is output as the image characteristic, and an image processing parameter for realizing the contrast image is output as the image processing condition. As an example, an image processing parameter for generating a non-contrast image from a contrast image is established based on a difference in features between the contrast image and the non-contrast image related to an identical anatomical site. It suffices that the contrast image and the non-contrast image used for determining the image processing condition are selected from medical images accumulated in a PACS database. The processing circuitry 31 carries out, based on the established image processing condition, image processing such as signal value conversion on the contrast image (first medical image) related to the subject, and generates the non-contrast image (second medical image). Note that the image processing may be performed by employing a deep neural network in which a non-contrast image is generated from a contrast image.

Thereafter, a second analysis process (SC10), transmission of a first analysis result and a second analysis result (at SC11), and displaying of the analysis results (SC12) are performed. The steps SC10, SC11, and SC12 are similar to steps SA14, SA15, and SA16, respectively.

After step SC12, the automatic analysis process by the medical image processing system 100 according to Modification 7 is completed.

According to Modification 7, it is possible for the medical image processing apparatus 300 to obtain the second medical image without making an obtaining request for the second medical image to the medical imaging apparatus 200. It is thereby possible to reduce the load on the medical imaging apparatus 200 caused by obtaining the second medical image, and to obtain the second medical image without bypassing the medical imaging apparatus 200, thus shortening the time taken to obtain the second medical image.

According to at least one of the embodiments described above, it is possible to specify, with ease, a medical image suitable for an additional analysis process to be performed in accordance with the analysis result of the medical image.

The term “processor” used in the above explanation means, for example, circuitry such as a central processing unit (CPU), a graphics processing unit (GPU), an application-specific integrated circuit (ASIC), or a programmable logic device (e.g., a simple programmable logic device (SPLD), a complex programmable logic device (CPLD), or a field programmable gate array (FPGA)). The processor reads programs stored in storage circuitry and executes them to realize the intended functions. Note that the programs may be incorporated directly in circuits of the processor, instead of being stored in the storage circuitry. In this case, the processor reads the programs incorporated in its circuits and executes them to realize the functions. If the processor is, for example, an ASIC, the functions are directly incorporated into the circuitry of the processor as logic circuitry, instead of the programs being stored in the storage circuitry. Note that the configuration of the present embodiment is not limited to the case where each processor is configured as a single circuit, and multiple independent circuits may be combined and integrated as a single processor to realize the intended functions. Furthermore, multiple constituent elements as given in FIGS. 1 to 3 and 10 may be integrated as a single processor to realize the respective functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing system, comprising a medical image processing apparatus and a medical imaging apparatus, the medical image processing apparatus and the medical imaging apparatus being communicably connected to each other, wherein
the medical image processing apparatus is configured to:
receive a first medical image related to a subject from the medical imaging apparatus;
execute a first analysis process for the first medical image to output a first analysis result;
determine, based on the first analysis result, whether or not a second analysis process is required as an additional analysis process; and
establish, if it has been determined that the second analysis process is required, an image characteristic recommended to be equipped in a second medical image used in the second analysis process in accordance with a processing content of the second analysis process.

2. The medical image processing system according to claim 1, wherein
the medical image processing apparatus is configured to:
transmit, to the medical imaging apparatus, the image characteristic and a request for obtaining the second medical image related to the subject;
receive, from the medical imaging apparatus, the second medical image obtained by the medical imaging apparatus in response to the obtaining request; and
execute the second analysis process for the second medical image to output a second analysis result.

3. The medical image processing system according to claim 2, further comprising:
a medical image display apparatus communicably connected to the medical image processing apparatus, wherein
the medical image processing apparatus is configured to transmit the first analysis result and the second analysis result to the medical image display apparatus, and
the medical image display apparatus is configured to display the first analysis result and the second analysis result on display equipment.

4. The medical image processing system according to claim 3, wherein
the medical image display apparatus is configured to:
display the first analysis result and the second analysis result side by side on a single screen, and
set, to the second analysis result, a visual effect indicating that the second analysis result is a result of the additional analysis process.

5. The medical image processing system according to claim 2, wherein
the medical imaging apparatus is configured to:
obtain the second medical image equipped with the image characteristic, without performing additional medical imaging; and
transmit the second medical image to the medical image processing apparatus.

6. The medical image processing system according to claim 5, wherein
the medical imaging apparatus is configured to:
read, if the second medical image is stored in a storage device, the second medical image from the storage device; and
generate, if the second medical image is not stored in the storage device, the second medical image from raw data stored in the storage device, based on an image generation condition corresponding to the image characteristic.

7. The medical image processing system according to claim 6, wherein
the medical image processing apparatus is configured to:
convert the image characteristic into the image generation condition defined by a specification adopted by the medical imaging apparatus, and transmit the image generation condition to the medical imaging apparatus, and
the medical imaging apparatus is configured to:
generate, if the second medical image is not stored in the storage device, the second medical image from the raw data, based on the image generation condition.

8. The medical image processing system according to claim 6, wherein
the medical image processing apparatus is configured to:
transmit the image characteristic to the medical imaging apparatus; and
convert the image characteristic into the image generation condition defined by a specification adopted by the medical image processing apparatus, and
the medical imaging apparatus is configured to:
generate, if the second medical image is not stored in the storage device, the second medical image from the raw data, based on the image generation condition.

9. The medical image processing system according to claim 5, wherein
the medical imaging apparatus is configured to:
display, on display equipment, a window for allowing a user to confirm whether or not to accept provision of the second medical image; and
obtain the second medical image in response to the user instructing, via the window, that the provision of the second medical image be accepted.

10. The medical image processing system according to claim 5, wherein
the medical imaging apparatus is configured, if there are a plurality of second medical images, to obtain the second medical image in accordance with priorities assigned based on whether or not each of the plurality of second medical images is obtainable and a time required to obtain each of the plurality of second medical images.

11. The medical image processing system according to claim 5, wherein
the medical imaging apparatus is configured to set, to the second medical image, a flag designating the second medical image, and
the medical image processing apparatus is configured to forgo, on the second medical image to which the flag is set, a process of determining whether or not an additional analysis process is required.

12. The medical image processing system according to claim 5, wherein
the medical image processing apparatus is configured to:
determine whether or not to adopt the second medical image, and
execute the second analysis process for the second medical image if it has been determined to adopt the second medical image, and not execute the second analysis process for the second medical image if it has been determined to not adopt the second medical image.

13. The medical image processing system according to claim 1, wherein
the first analysis process is a process in which a spatial distribution of a plurality of probability values each denoting a likelihood of a tumor is calculated based on the first medical image, a tumor region is detected from the first medical image based on a comparison between each of the plurality of probability values and a first threshold value, and a location of the detected tumor region is output,
the medical image processing apparatus is configured to determine that the second analysis process is required if a difference between each of the plurality of probability values and the first threshold value is smaller than a second threshold value,
the second analysis process includes a processing content identical to the first analysis process, and is performed to improve precision of detection of the tumor region, as compared to the first analysis process, and
the image characteristic is a characteristic of having a high contrast between a normal tissue region and the tumor region as compared to the first medical image.

14. The medical image processing system according to claim 1, wherein
the first analysis process is a process in which a spatial distribution of a plurality of probability values each denoting a likelihood of a tumor is calculated based on the first medical image, a tumor region is detected from the first medical image based on a comparison between each of the plurality of probability values and a first threshold value, and a location of the detected tumor region is output,
the medical image processing apparatus is configured to determine that, if the location of the tumor region is output through the first analysis process and determination of a radiation therapy effect is required, the second analysis process is required,
the second analysis process is a process of detecting whether or not a feeding vessel to the tumor region is present, and
the image characteristic is a characteristic of having a high contrast between a blood flow region and another region, as compared to the first medical image.

15. The medical image processing system according to claim 1, wherein
the first analysis process is a process in which a spatial distribution of a plurality of probability values each denoting a likelihood of a tumor is calculated based on the first medical image, a tumor region is detected from the first medical image based on a comparison between each of the plurality of probability values and a first threshold value, and a location of the detected tumor region is output,
the medical image processing apparatus is configured to determine that, if the location of the tumor region is not output through the first analysis process and a hippocampal region is included in the first medical image, the second analysis process is required,
the second analysis process is a process of measuring a volume of the hippocampal region, and
the image characteristic is a characteristic of having a high spatial resolution as compared to the first medical image.

16. The medical image processing system according to claim 1, wherein
the first analysis process is an analysis process included in and common to all of a plurality of applications,
the second analysis process is an analysis process included in each of the plurality of applications and not common to the plurality of applications, and
the medical image processing apparatus is configured to establish the image characteristic in accordance with the non-common analysis process for some or all of the plurality of applications.

17. The medical image processing system according to claim 1, wherein
the medical image processing apparatus is configured to generate the second medical image from the first medical image based on an image processing condition corresponding to the image characteristic.

18. The medical image processing system according to claim 1, wherein
the image characteristic is a spatial resolution, an inter-tissue contrast, a slice thickness, a matrix size, and/or a slice position.

19. A medical image processing apparatus comprising processing circuitry configured to:
execute a first analysis process for a first medical image related to a subject to output a first analysis result;
determine, based on the first analysis result, whether or not a second analysis process is required as an additional analysis process;
establish, if it has been determined that the second analysis process is required, an image characteristic recommended to be equipped in a second medical image used in the second analysis process in accordance with a processing content of the second analysis process;
transmit, via communication equipment, the image characteristic and an obtaining request for the second medical image to a medical imaging apparatus which has generated the first medical image;
receive, from the medical imaging apparatus via communication equipment, the second medical image related to the subject and obtained by the medical imaging apparatus in response to the obtaining request; and
execute the second analysis process for the second medical image to output a second analysis result.

20. A medical imaging apparatus comprising processing circuitry, configured to:
receive, from a medical image processing apparatus via communication equipment, a request for obtaining a specific medical image and an image characteristic recommended to be equipped in the specific medical image;
store raw data of the specific medical image in a memory;
convert the image characteristic into an image generation condition for generating the specific medical image, the image generation condition being defined by a specification adopted by the medical imaging apparatus;
generate, based on the image generation condition, the specific medical image equipped with the image characteristic from the raw data; and
transmit, via communication equipment, the generated specific medical image to the medical image processing apparatus.
